(19) United States
(12) Patent Application Publication
(10) Pub. No.: US 2021/0142801 A1
(43) Pub. Date: May 13, 2021

(54) DETERMINING A CONTROLLER FOR A CONTROLLED SYSTEM

(71) Applicant: Ford Global Technologies, LLC, Dearborn, MI (US)

(72) Inventor: Frederic Stefan, Aachen (DE)

(73) Assignee: Ford Global Technologies, LLC, Dearborn, MI (US)

(21) Appl. No.: 17/088,789

(22) Filed: Nov. 4, 2020

(30) Foreign Application Priority Data
Nov. 13, 2019 (DE) 102019130609.4

(51) Int. Cl. G10L 15/22; G06F 3/16; G06N 20/00; G06N 3/02; B60W 30/14

(52) U.S. Cl. CPC G10L 15/22; G06F 3/167; B60W 30/14; G06N 3/02; G06N 20/00

(57) ABSTRACT

A determination of a controller for a controlled system includes reading in a data record representative of a task of the controller, selecting a controller type for the controller from a group of archived controller type data records by evaluating the data record using machine learning, selecting a control quality data record including archived values for a control quality of the selected controller type using the machine learning, and outputting an output data record that includes the controller type and the control quality data record.

### CROSS REFERENCE TO RELATED APPLICATIONS

This patent application claims priority to German Application No. 102019130609.4, filed Nov. 13, 2019, which is hereby incorporated herein by its reference in its entirety.

### BACKGROUND

Motor vehicles have an increasing number of driving assistance systems that have controlled systems with controllers. Controller design for the controllers takes into consideration, e.g., the respective application, a vehicle architecture, predetermined control qualities, and the type of sensors and actuators.

Different controller types can be used depending on the control task to be completed, such as continuous-action controllers (e.g., PID controllers or state controllers), non-linear controllers (e.g., fuzzy controllers or adaptive controllers), or discontinuous-action controllers (e.g., two-level controllers).

### SUMMARY

Selection of the controller type for the respective task is a fundamental part of controller design that is performed on the basis of many years of experience by people responsible for this task.

There is thus a need to demonstrate ways in which assistance in the selection of the controller type can be provided.

Described herein is a method for determining a controller for a controlled system, having the steps of:
reading in a data record representative of a task of the controller,
selecting a controller type for the controller from a group of archived controller type data records by evaluating the data record using machine learning,
selecting a control quality data record that includes archived values for a control quality of the selected controller type using the machine learning, and
outputting an output data record that includes the controller type and the control quality data record.

In other words, a two-step computer-implemented method is proposed in which the first step involves a suitable controller type first being selected on the basis of the control task and then a second step involves the control quality achieved using the selected controller type in earlier applications being used. These selection processes are performed by machine learning. To this end, the machine learning may be designed for monitored or unmonitored learning. Furthermore, the machine learning can have artificial neural networks, such as deep neural networks, and/or algorithms for classification.

According to one example, a data record and/or controller type data record and/or control quality data record available in a modeling language is used. Modeling languages allow demands on an organization system or a software system and the structures and internal processes thereof to be defined at a higher abstraction level. Known modeling languages are, e.g., UML (Unified Modeling Language), a graphical modeling language for specifying, designing, and documenting software components and other systems; and SysML (Systems Modeling Language), a graphical, UML 2-based, standardized modeling language. This is used in the field of systems engineering for modeling various complex systems. Therefore, the data record and/or controller type data record and/or control quality data record can be created particularly easily.

According to a further example, the output data record includes a controller type data record that completes the task for the controller. In other words, at least one controller is proposed for the task to be completed. As a departure therefrom, there may also be provision for a plurality of controllers to be proposed for the task to be completed.

According to a further example, the output data record includes a controller type data record that meets predetermined control quality specifications for the controller. A controller type is therefore proposed that meets the requirements according to the control quality specifications. There may also be provision for a predetermined rating rule to be used for rating the different controller types in terms of the degree to which they meet the predetermined control quality specifications. Therefore, it is also possible for multidimensional controller qualities comprising multiple variables to be taken into consideration. Furthermore, there may be provision for only controllers that have a minimum value according to the predetermined rating rule to be proposed. That is to say, therefore, that not all controller types but rather, e.g., only the best three controller types are proposed.

According to a further example, a selected controller type data record together with associated values for a control quality are used as data for machine learning by the system. Proven controller types are therefore used as training data for monitored learning by the machine learning.

The described method can be implemented by a computer program product or a system.

### BRIEF DESCRIPTION OF THE DRAWINGS

FIG. 1 shows a schematic depiction of a controlled system with a controller.

FIG. 2 shows a schematic depiction of a system for determining a controller for a controlled system.

FIG. 3 shows a schematic depiction of a process for determining a controller for a controlled system.

### DETAILED DESCRIPTION

Reference will first be made to FIG. 1.

The figure shows a control loop having a controller 2 and a controlled system 4, wherein, as customary, the output signal is fed back to the input and a difference between the fed-back input variable and a setpoint value is supplied to the controller as input.

The control loop having the controller 2 and the controlled system 4 may be part of a driving assistance system of a motor vehicle, such as, e.g., an adaptive cruise control (ACC).

The design of a controller involves a controller type R being selected for the controller 4. The controller type R can be a continuous-action controller, such as a PI or PID controller, a state controller, e.g., with state feedback or output feedback. A possible controller type R may alternatively be a nonlinear controller 4, such as a fuzzy controller, an adaptive controller, or an extreme value controller. In addition, discontinuous-action controllers 4 may also be possible as controller types R, such as two-level or multilevel controllers. The controller type R may also be a single-variable system (SISO) or else a multiple-variable system (MIMO).

To facilitate selection of the controller type R for the controller 4 there is provision for a system 6, in the present example a computer-aided engineering (CAE) system, which will now be explained with additional reference to FIG. 2.

Besides a user 8, such as a person responsible for controller design, the following components of the system 6 are depicted: an interface 10, an application database 12, a vehicle architecture database 14, a control quality database 16, a control type database 18, an archive database 20, a communication unit 22, and an evaluation unit 24.

The system 6 or the cited components can have hardware and software components for their tasks and/or functions described below.

The interface 10 may be a terminal, such as a personal computer (PC), that the user 8 can use to access and use the system 6. The terminal 10 can be used by the user 8 to formulate a task for the controller 2, e.g., in a modeling language such as UML or SysML. The result is that a data record DS representative of the task of the controller 2 is provided.

The data record DS can be regarded as a formal specification of the control strategy to be implemented. It may be written in application-based or vehicle-architecture-oriented or control-quality-oriented fashion.

The application database 12 is a reference database for applications. The applications can be modeled in a formal manner using a modeling language, such as SysML or UML.

The applications archived in the application database 12 comprise functions that have been developed or are in development. The applications archived in the application database 12 may be associated with specific vehicle architectures, such as automatic gearbox vehicle or microhybrid vehicle architecture, or may be associated with specific control aims, such as control of the vehicle speed at low speed, and therefore the need for jerky movements to stop within predetermined limits. The applications may also be associated with generic controller types R and with a specific implementation according to the archive database 20.

The vehicle architecture database 14, on the other hand, is a reference database for vehicle architectures. The vehicle architecture can include a functional architecture and a software architecture. These reflect the target platform on which specific control software can be implemented. The architecture can be modeled using a modeling language, such as SysML or UML. The vehicle architecture may have specific applications, predetermined control qualities RG (see FIG. 3), generic controller types R, and a specific implementation according to the archive database 20 associated with it.

The control quality database 16 is a reference database for control qualities. The control quality RG describes the performance and the vehicle properties that are supposed to be implemented, e.g., acceleration, jolts, overshoots, etc. In this instance the control quality R is understood to mean a measure of the control response of a closed-loop control system. It can be used to make a statement about the quality of the closed-loop control system. The quality measure in this instance needs to be adapted for the particular desired control response (controlled variable, setpoint value, manipulated value). The quality measures are customarily based on, e.g., norms such as the L1 norm (rapid control response, ITAE criterion), the L2 norm (quadratic quality criterion, minimum amplitudes), the maximum norm (maximum possible ratio of energies or outputs of error variables to input variables), or, in particular for periodic signals, the average power. The norms in this instance each weight specific deviations particularly highly and can therefore be selected according to the type of problem.

Control qualities RG are typically connected to specific applications, to specific vehicle architectures, to generic controller types R, and to the implementation of specific control software.

The controller type database 18 is a reference database including generic controller types R and proven methods in regard to control quality, applications, and vehicle architectures. The controller types R may be known from the literature and theory in the context of control loops.

The archive database 20 is a reference database for controllers 2 that have been implemented in respect of predetermined control qualities RG, applications, and vehicle architectures. The archive database 20 includes a control strategy that was implemented successfully earlier. The controller type data records RTD archived in the archive database 20 can be based on historical data of a company and possibly from suppliers.

The communication network 22 is designed to ensure, during operation, an interchange of data between the cited components of the system 6.

The evaluation unit 24 is a core system hosting the methods and algorithms. The evaluation unit 24 affords multiple modes of operation:
A query mode in order to provide a controller type R or a list including multiple controller types R for completing the control task. In this regard a selection can be made, e.g., according to the vehicle architectures, applications, or predetermined control quality RG.
A query mode in order to provide a list including multiple controller types R in use. In this case too, a selection can be made, e.g., according to the vehicle architectures, applications, or predetermined control quality RG.
A rating mode in order to determine the accuracy of each selected controller type R. In this case a comparison of the selected controller types R can be made, e.g., according to the vehicle architectures, applications, or predetermined control quality RG. This can include determining the similarity according to the description in the modeling language, i.e., a text similarity analysis.
An output mode in order to provide one or more controller types R. In this instance the previously determined accuracy can be used to form a list. There can also be provision for a comparison with a predetermined limit value for the accuracy and, on this basis, a selection comprising multiple controller types R.
An analysis mode for analyzing the controller type R selected by the user 8 in order to improve the system 6 by means of machine learning, in particular monitored learning. This can include determining a value indicative of the differences between a proposed controller type R and a controller type R selected by the user 8.
A validation mode for validating a controller type R. This permits testing of a control design beforehand, e.g., as a Simulink model. This can also include determining a value indicative of the differences between the proposed control design and archived controller types R.

A method sequence for the operation of the system 6 will now be explained with additional reference to FIG. 3.

In a first step S100 the data record DS, in the present case in a modeling language, representative of a task of the controller 2 is read in.

In a further step S200 the controller type R for the controller 2 is selected from a group of archived controller type data records RTD in a modeling language by evaluating the data record DS using the system 6, which performs machine learning, in the present example by means of the evaluation unit 24.

In a further step S300 the control quality data record RD in a modeling language including archived values for the control quality RG of the selected controller type R is selected using the system 6, which performs the machine learning, in the present example by means of the evaluation unit 24.

In a further step S400 the output data record AD including the specific controller type R and the associated control quality data record RD is outputted.

The output data record AD can include a controller type data record RTD that completes the task for the controller 2. Alternatively, the output data record AD can include a controller type data record RTD that meets the predetermined control quality specifications for the controller 2.

Additionally, the output data record AD can have a controller type data record RTD that meets predetermined control quality specifications for the controller 2. A controller type R is therefore proposed that meets the requirements according to the control quality specifications. There may also be provision for a predetermined rating rule to be used to rate the different controller types R in terms of the degree to which they meet the predetermined control quality specifications. Therefore, it is also possible for multidimensional controller qualities comprising multiple variables to be taken into consideration. Furthermore, there may be provision for only controllers 2 that have a minimum value according to the predetermined rating rule to be proposed. That is to say, therefore, that not all controller types R but rather, e.g., only the best three controller types R are proposed.

In addition, the selected controller type data record RTD together with associated values for a control quality RG can be used as data for machine learning by the system 6, in particular for monitored learning.

As a departure from the present example, the order of the steps may also be different. Furthermore, multiple steps can also be carried out at the same time or simultaneously. In addition, individual steps can also be skipped or omitted as a departure from the present example.

A two-step computer-implemented method is thus proposed in which the first step involves a suitable controller type first being selected on the basis of the control task and then a second step involves the control quality achieved using the selected controller type in earlier applications being used, in order thus to provide assistance in the selection of the controller type.

### LIST OF REFERENCE SIGNS

2 controller
4 controlled system
6 system
8 user
10 interface
12 application database
14 vehicle architecture database
16 control quality database
18 controller type database
20 archive database
22 communication unit
24 evaluation unit
AD output data record
DS data record
R controller type
RD control quality data record
RG control quality
RTD controller type data record
S100 step
S200 step
S300 step
S400 step

1-11. (canceled)

12. A system comprising:
an interface; and
a computer accessible by the interface and programmed to:
read in a data record representative of a task of a controller;
select a controller type for the controller from a group of archived controller type data records by evaluating the data record using machine learning;
select a control quality data record that includes archived values for a control quality of the selected controller type using the machine learning, and
output an output data record that includes the controller type and the control quality data record.

13. The system of claim 12, wherein the data record is in a modeling language.

14. The system of claim 12, wherein the controller type data records are in a modeling language.

15. The system of claim 12, wherein the control quality data record is in a modeling language.

16. The system of claim 12, wherein the output data record includes one of the controller type data records selected to complete the task for the controller.

17. The system of claim 12, wherein the output data record includes a controller type data record that meets predetermined control quality specifications for the controller.

18. The system of claim 12, wherein the selected controller type together with associated values for the control quality are used as data for selecting the control quality data record using the machine learning.

19. The system of claim 12, wherein the machine learning includes deep neural networks.

20. The system of claim 12, wherein the task is adaptive cruise control.

21. The system of claim 12, wherein the control quality is a measure of a control response of a closed-loop control system including the controller.

22. A method for determining a controller for a controlled system, comprising:
reading in a data record representative of a task of the controller;
selecting a controller type for the controller from a group of archived controller type data records by evaluating the data record using a machine learning;
selecting a control quality data record that includes archived values for a control quality of the selected controller type using the machine learning, and
outputting an output data record that includes the controller type and the control quality data record.

23. The method of claim 22, wherein the data record is in a modeling language.

24. The method of claim 22, wherein the controller type data records are in a modeling language.

25. The method of claim 22, wherein the control quality data record is in a modeling language.

26. The method of claim 22, wherein the output data record includes one of the controller type data records selected to complete the task for the controller.

27. The method of claim 22, wherein the output data record includes a controller type data record that meets predetermined control quality specifications for the controller.

28. The method of claim 22, wherein the selected controller type together with associated values for the control quality are used as data for selecting the control quality data record using the machine learning.

29. The method of claim 22, wherein the machine learning includes deep neural networks.

30. The method of claim 22, wherein the task is adaptive cruise control.

31. The method of claim 22, wherein the control quality is a measure of a control response of a closed-loop control system including the controller.
